(19) United States
(12) Patent Application Publication
(10) Pub. No.: US 2026/0231858 A1
(43) Pub. Date: Aug. 13, 2026

(54) POWER OPERATED REEL-TYPE ROTARY MOWER WITH FRONT TRIMMER

(71) Applicants: Jae Sik MIN, Hwaseong-si (KR); Yoon Ju SA, Gapyeong-gun (KR)

(72) Inventors: Jae Sik MIN, Hwaseong-si (KR); Yoon Ju SA, Gapyeong-gun (KR)

(21) Appl. No.: 19/534,022

(22) Filed: Feb. 9, 2026

(30) Foreign Application Priority Data
Feb. 10, 2025 (KR) 10-2025-0016680

(51) Int. Cl. A01D 34/58; A01D 34/52; A01D 34/62; A01D 101/00

(52) U.S. Cl. CPC A01D 34/58; A01D 34/52; A01D 34/62; A01D 2101/00

(57) ABSTRACT

A reel-type rotary mower includes: a driving unit connected to a drive shaft configured to receive power from a motor; a driven shaft disposed to intersect the driving unit and extending in a transverse direction, the driven shaft being operatively connected to the driving unit and configured to rotate by rotation of the drive shaft; side covers inserted into the driven shaft and spaced apart from each other on opposite sides of the driven shaft; wheels coupled to the side covers and having gear teeth formed along inner circumferential surfaces thereof and gear-engaged with end portions of the driven shaft; a blade shaft gear-engaged with the gear teeth; a plurality of blades connected to the blade shaft and extending in the transverse direction; and a weight rotatably connected between the side covers to support a load.

### CROSS-REFERENCE TO RELATED APPLICATION(S)

This application claims priority to Korea Patent Application No. 10-2025-0016680, filed Feb. 10, 2025, the contents of which are incorporated by reference in its entirety.

### TECHNICAL FIELD

The present invention relates to a mower configured to be operated by a user while being pushed using wheels, and more particularly, to a power operated reel-type rotary mower that is connected to a power source and driven thereby.

### BACKGROUND ART

Conventional manual reel-type mowers using wheels are configured such that, when a user places the mower on a grass-covered ground surface and manually pushes the mower, reel-type blades connected to an inner portion of the wheels rotate to continuously cut grass.

Such manual reel-type mowers have been widely used due to advantages including a relatively simple structure, low failure rates, low manufacturing cost, and efficient grass-cutting performance.

However, due to the limitations inherent in manual operation, operators are easily fatigued during use, and the cutting width is relatively narrow because the mower relies solely on manual force, thereby limiting practical usability.

In contrast, various power-assisted mowers have been developed, but such mowers are generally expensive, making them difficult to access for users who manage relatively small areas.

Accordingly, if a conventional manual reel-type mower is provided with a power source to form a power operated reel-type rotary mower, it becomes possible to provide a mower that is relatively inexpensive, highly practical, and capable of reducing operator fatigue.

In addition, in conventional manual reel-type mowers, reel-type blades connected to the inner portion of the wheels are suitable for cutting small grass such as lawn grass, but have difficulty cutting relatively large or thick grass.

To solve this problem, if a power source is added to a conventional manual reel-type mower and a front trimmer capable of cutting relatively large grass is further provided, and if the trimmer is configured to be driven together using the same power source, the overall utility and functionality of the mower can be further improved.

### DISCLOSURE

### Technical Problem

Accordingly, the present invention has been made in view of the circumstances described above, and an object thereof is to provide a power operated reel-type rotary mower with a front trimmer, which can be operated by a user while being pushed using wheels, and in which a power source is added to rotate the wheels by power while simultaneously driving a reel-type blade for cutting grass and a front trimmer capable of cutting relatively large grass.

### Technical Solution

In order to achieve the above object, a reel-type rotary mower according to the present invention includes:
a driving unit connected to a drive shaft configured to receive power from a motor;
a driven shaft disposed to intersect the driving unit and extending in a transverse direction, the driven shaft being operatively connected to the driving unit and configured to rotate by rotation of the drive shaft;
side covers inserted into the driven shaft and spaced apart from each other, the side covers being disposed respectively on opposite sides of the driven shaft;
wheels coupled to the side covers, each wheel having gear teeth formed along an inner circumferential surface thereof and being gear-engaged with an end portion of the driven shaft so as to rotate in response to rotation of the driven shaft;
a blade shaft gear-engaged with the gear teeth and configured to rotate together with rotation of the gear teeth;
a plurality of blades connected to the blade shaft and extending in the transverse direction; and
a weight rotatably connected between the side covers and configured to support a load,
wherein rotational power of the motor is sequentially transmitted to the drive shaft, the driven shaft, and the wheels, such that the blades rotate to cut grass.

In addition, each of the side covers includes a driven-shaft opening into which an end portion of the driven shaft is inserted and rotatably supported, and a blade-shaft opening into which an end portion of the blade shaft is inserted and rotatably supported.

Further, the reel-type rotary mower includes:
a second drive shaft operatively connected to the drive shaft and extending in a longitudinal direction;
an upper trimmer blade and a lower trimmer blade disposed in front of the wheels in the transverse direction; and
a trimmer driving unit operatively connected to the second drive shaft and coupled to the upper trimmer blade and the lower trimmer blade, the trimmer driving unit being configured such that rotation of the second drive shaft causes the upper trimmer blade and the lower trimmer blade to repeatedly move toward and away from each other to cut relatively large grass,
wherein rotation of the second drive shaft causes the driven shaft, the upper trimmer blade, and the lower trimmer blade to be driven together.

Further, the driving unit includes a driving rotary portion configured to rotate together with rotation of the drive shaft, and an adapter includes an adapter driving portion coupled to the driving unit and gear-engaged with the driving rotary portion so as to rotate, wherein the second drive shaft is gear-engaged with the adapter driving portion so as to rotate.

### Advantageous Effects

According to the present invention, it is possible to provide a power operated reel-type rotary mower that can be operated by a user while being pushed using wheels, and in which the wheels are rotated by power using a power source, while a reel-type blade for cutting grass and a front trimmer capable of cutting relatively large grass are simultaneously driven using a single power source, thereby improving work efficiency and reducing operator fatigue.

### DESCRIPTION OF DRAWINGS

FIG. 1 is a view illustrating an overall configuration of a reel-type rotary mower according to an embodiment of the present invention.

FIG. 2 is a view illustrating a state in which side covers are removed from the mower of FIG. 1.

FIG. 3 is a view illustrating a state in which a front cover is removed from the mower of FIG. 1.

FIG. 4 is a view illustrating a state in which a driving unit of the reel-type rotary mower of FIG. 1 is disassembled.

FIG. 5 is a view illustrating a driving unit for driving a front trimmer in the reel-type rotary mower according to the present invention.

FIG. 6 is a detailed view illustrating an assembled state of the driving unit of the reel-type rotary mower according to the present invention.

FIG. 7 is a detailed view illustrating a driven shaft portion in FIG. 2.

FIG. 8 is an enlarged view illustrating a partial configuration of FIG. 7.

### MODE FOR INVENTION

Hereinafter, preferred embodiments of the present invention will be described in detail with reference to the accompanying drawings. In the drawings, the same reference numerals are used to designate the same or corresponding components throughout the drawings, even if they are illustrated in different drawings.

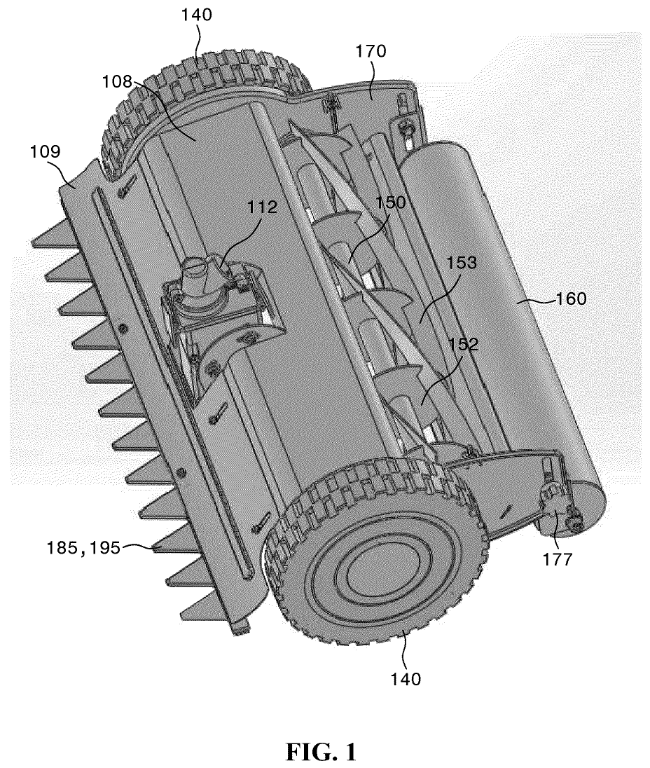

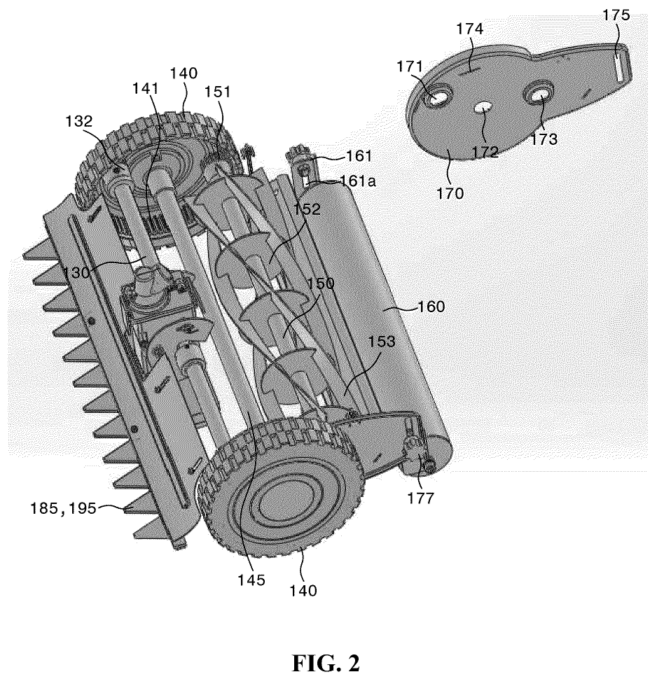

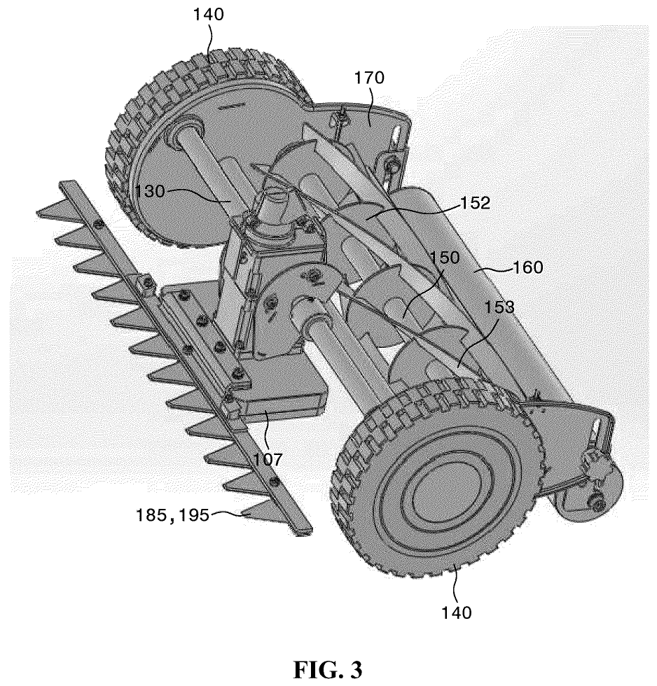

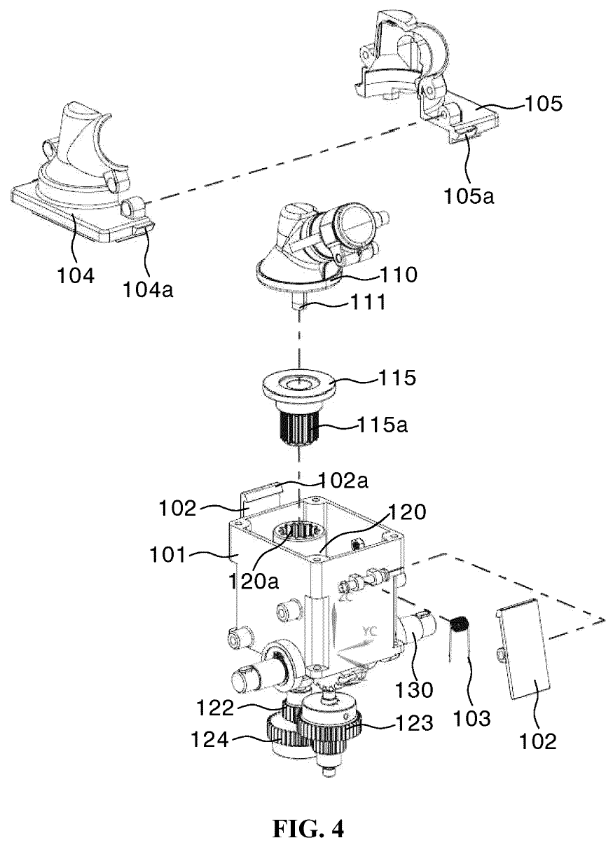

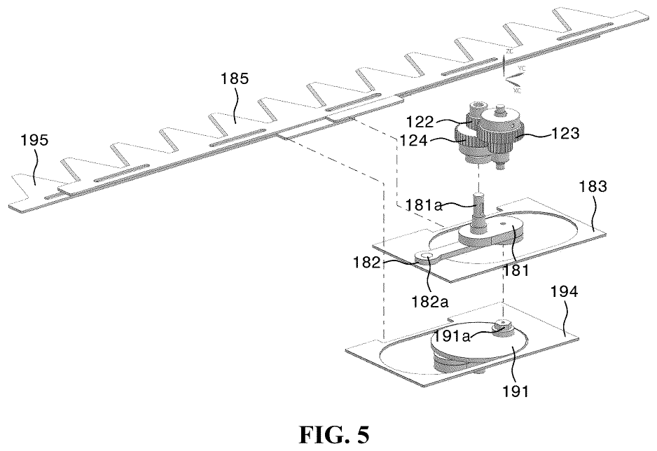

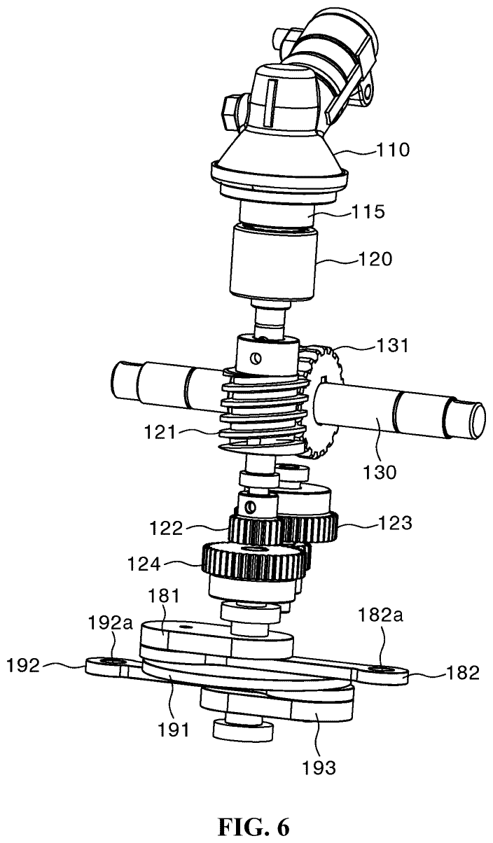

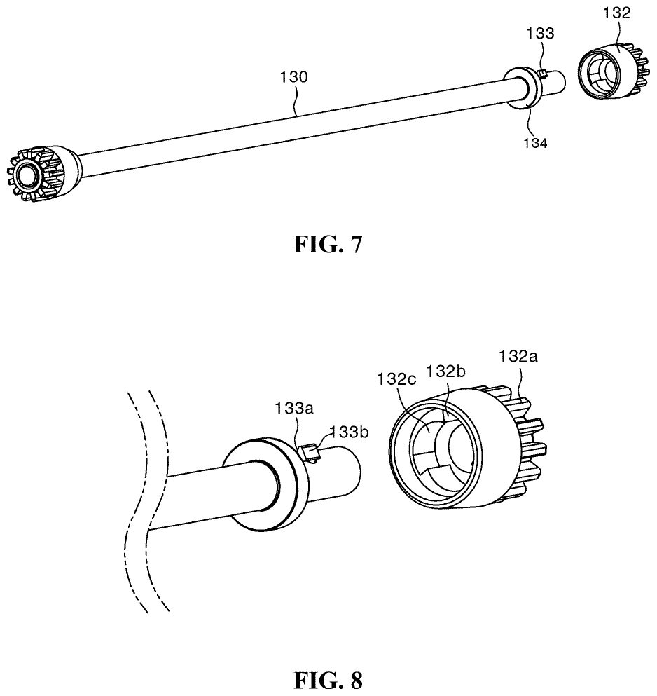

FIG. 1 is a view illustrating an overall configuration of a reel-type rotary mower according to an embodiment of the present invention. FIG. 2 is a view illustrating a state in which side covers are removed from the mower of FIG. 1. FIG. 3 is a view illustrating a state in which a front cover is removed from the mower of FIG. 1. FIG. 4 is a view illustrating a disassembled state of a driving unit of the reel-type rotary mower of FIG. 1. FIG. 5 is a view illustrating a driving unit for driving a front trimmer in the reel-type rotary mower according to the present invention. FIG. 6 is a detailed view illustrating an assembled state of the driving unit of the reel-type rotary mower according to the present invention. FIG. 7 is a detailed view illustrating a driven shaft portion of FIG. 2. FIG. 8 is an enlarged view illustrating a partial configuration of FIG. 7.

Referring to FIGS. 1 through 6, the reel-type rotary mower according to the present invention includes a drive shaft (not shown), a driving unit 110, an adapter 115, a second drive shaft 120, a driven shaft 130, side covers 170, wheels 140, a weight 160, a blade shaft 150, blades 153, an upper trimmer blade 185, a lower trimmer blade 195, and a trimmer driving unit.

The drive shaft is operatively connected to a motor and extends in a longitudinal direction. The drive shaft may have the same configuration as that of a conventional mower. For example, a power transmission shaft including a motor may be connected to the drive shaft in a form wearable by an operator over a shoulder, as in conventional mowers.

The driving unit 110 is connected to the drive shaft and includes a driving rotary portion 111 that rotates together with the drive shaft. The driving unit 110 includes a drive-shaft insertion portion 112 into which the drive shaft is inserted. The driving unit 110 may have the same configuration as a driving unit provided in a conventional mower.

The second drive shaft 120 is operatively connected to the drive shaft by a female gear 120a and extends in the longitudinal direction. A worm gear 121 is formed at a central portion of the second drive shaft 120, and a spur gear 122 may be formed at a lower end portion thereof.

The adapter 115 is coupled to the driving unit 110 and includes an adapter driving portion 115a that is gear-engaged with the driving rotary portion 111 so as to rotate. The second drive shaft 120 is gear-engaged with the adapter driving portion 115a and is thereby configured to rotate. The adapter 115 serves as a component that connects the driving unit 110 and the second drive shaft 120 to enable transmission of power.

The driven shaft 130 extends in a transverse direction and is disposed to intersect the drive shaft and the driving unit 110, such that the driven shaft 130 rotates in response to rotation of the drive shaft. A worm wheel gear 131 is formed at a central portion of the driven shaft 130 and is engaged with the worm gear 121 to transmit power from the motor to the driven shaft 130.

The side covers 170 are inserted into the driven shaft 130 and are spaced apart from each other so as to be disposed respectively on opposite sides of the driven shaft 130. Each side cover 170 is formed in a plate shape and includes a circular portion corresponding to the wheel 140, and a rear protruding portion integrally connected to the circular portion and protruding rearwardly.

Each side cover 170 includes a driven-shaft opening 171 into which an end portion of the driven shaft 130 is inserted and rotatably supported, and a blade-shaft opening 173 into which an end portion of the blade shaft 150 is inserted and rotatably supported. A wheel-connecting-shaft opening 172 into which a wheel connecting shaft 145 is inserted is formed at a central portion of each side cover 170.

The wheels 140 are coupled to the side covers 170, and gear teeth 141 formed along an inner circumferential surface thereof are gear-engaged with driven shaft gears 132 formed at end portions of the driven shaft 130 (see FIG. 7), such that the wheels 140 rotate in response to rotation of the driven shaft 130. The wheels 140 on both sides are connected to the wheel connecting shaft 145 and rotate about the wheel connecting shaft 145. Power from the motor is transmitted through the worm gear 121, the worm wheel gear 131, the driven shaft gears 132, and the gear teeth 141, such that the wheels 140 rotate as the motor rotates.

The blade shaft 150 is operatively connected to the wheels 140 so that the blades 153 rotate as the wheels 140 rotate. Blade gears 151 are formed at both end portions of the blade shaft 150 and are operatively connected to the gear teeth 141 of the wheels 140. To this end, the blade-shaft opening 173 is formed in each side cover 170, and the end portions of the blade shaft 150 are inserted into the blade-shaft openings 173 and rotatably supported thereby. The blade-shaft opening 173 is positioned rearward of the wheel-connecting-shaft opening 172 of the side cover 170.

The blades 153 include cutting edges for cutting grass (or weeds), and are connected to the blade shaft 150 so as to extend in the transverse direction. In order to support the blades 153, a plurality of blade plates 152 formed in a disk shape and spaced apart from each other are mounted on the blade shaft 150. Each of the blade plates 152 includes blade slots formed along an outer circumferential surface thereof at predetermined intervals, into which the blades 153 are inserted and supported.

The weight 160 is formed in a cylindrical shape and is rotatably connected between rear protruding portions of the side covers 170 on both sides so as to support a load of the reel-type rotary mower as a whole. The weight 160 supports the weight of the reel-type rotary mower, thereby allowing the wheels 140 and the blades 153 to rotate while cutting grass.

Referring to FIG. 2, each rear protruding portion of the side cover 170 includes a weight-connecting groove 175 extending in the longitudinal direction, and the weight 160 includes a groove-forming portion 161 having a connecting groove 161a extending in the longitudinal direction. In a state in which the weight-connecting groove 175 and the connecting groove 161a are aligned with each other, a fastening member 177 is fastened through an opening of the grooves, such that the weight 160 and the side covers 170 are coupled to each other. Since the weight-connecting groove 175 and the connecting groove 161a extend in the longitudinal direction, a height of the weight 160 relative to the side covers 170 can be adjusted depending on a fastening position of the fastening member 177.

Referring to FIGS. 1 and 2, a front cover 108 is connected between the side covers 170 at a front side thereof so as to cover and protect an upper portion of the driven shaft 130. Protrusions are formed on both sides of the front cover 108, and the protrusions are inserted into front-cover insertion grooves 174 formed in the side covers 170, such that the front cover 108 is supported. In addition, a second front cover 109 is connected to and supported at a front side of the front cover 108.

Hereinafter, the trimmer blades of the present invention will be described with reference to FIGS. 3 through 6.

The blades 153 are positioned at a relatively low height from a ground surface and have relatively low cutting force, and thus are mainly used for cutting small grass such as lawn grass, while relatively large grass is difficult to cut by the blades 153. In the present invention, in order to cut relatively large grass that is difficult to cut by the blades 153, an upper trimmer blade (or trimmer blade) 185 and a lower trimmer blade (or trimmer blade) 195 are disposed in front of the wheels 140 in the transverse direction.

The upper trimmer blade 185 and the lower trimmer blade 195 have a configuration in which large cutting edges are continuously arranged at a front side thereof, and are configured such that the cutting edges repeatedly move toward and away from each other to cut relatively large grass.

The trimmer driving unit is operatively connected to the second drive shaft 120 and coupled to the upper trimmer blade 185 and the lower trimmer blade 195. The trimmer driving unit is configured such that rotation of the second drive shaft 120 causes the upper trimmer blade 185 and the lower trimmer blade 195 to repeatedly move toward and away from each other, thereby cutting relatively large grass.

As the second drive shaft 120 connected to the driving unit 110 rotates, the driven shaft 130, the upper trimmer blade 185, and the lower trimmer blade 195 are driven together, such that small grass such as lawn grass and relatively large grass can be cut together.

In order to drive the upper and lower trimmer blades 185 and 195, a reduction gear 123 is connected to the spur gear 122 formed at a lower end portion of the second drive shaft 120, and a trimmer driving gear 124 is connected to the reduction gear 123.

Referring to FIGS. 5 and 6, a first eccentric rotary portion 181 extending to one side from a shaft of the trimmer driving gear 124 is connected to the shaft. A first crank bar 182 is connected to an end of the first eccentric rotary portion 181 via a bearing. The first crank bar 182 extends past the shaft in a direction opposite to the end of the first eccentric rotary portion 181 and has a length greater than that of the first eccentric rotary portion 181. A first crank opening 182a is formed at an opposite end of the first crank bar 182, and an upper connection plate 183 is connected to the first crank opening 182a via a bearing.

The upper connection plate 183 is formed as a rectangular plate having an opening at a center thereof. The upper trimmer blade 185 is connected to the upper connection plate 183. The upper connection plate 183 is constrained within a trimmer housing 107 (see FIG. 3) so as to perform linear reciprocating motion in the transverse direction.

When the trimmer driving gear 124 rotates, the first eccentric rotary portion 181 rotates. As the first eccentric rotary portion 181 rotates, the first crank bar 182 functions as a connecting rod that converts rotational motion into linear motion, such that the upper connection plate 183 performs linear reciprocating motion in left and right directions. Accordingly, the upper trimmer blade 185 connected to the upper connection plate 183 performs the same linear motion.

A circular insertion rotary portion 191 is connected to the first eccentric rotary portion 181 via the first crank bar 182, and a second crank bar 192 is connected to an opposite side of the insertion rotary portion 191.

The second crank bar 192 extends in a direction opposite to the first crank bar 182 and has a length greater than that of the insertion rotary portion 191. A second crank opening 192a is formed at an opposite end of the second crank bar 192, and a lower connection plate 194 is connected to the second crank opening 192a via a bearing. A second eccentric rotary portion 193 is disposed at a lower portion of the second crank bar 192 so as to be eccentric with respect to a central axis, and the central axis is supported by the trimmer housing 107.

The lower connection plate 194 is formed as a rectangular plate having an opening at a center thereof, similarly to the upper connection plate 183. The lower trimmer blade 195 is connected to the lower connection plate 194. The lower connection plate 194 is constrained within the trimmer housing 107 so as to perform linear motion in the transverse direction.

When the trimmer driving gear 124 rotates, the first eccentric rotary portion 181 rotates, and the insertion rotary portion 191 rotates accordingly. As the insertion rotary portion 191 rotates, the second crank bar 192 functions as a connecting rod that converts rotational motion into linear motion, such that the lower connection plate 194 performs linear reciprocating motion in left and right directions. Accordingly, the lower trimmer blade 195 connected to the lower connection plate 194 performs linear motion in a direction opposite to that of the upper trimmer blade 185, such that the upper trimmer blade 185 and the lower trimmer blade 195 repeatedly move toward and away from each other to cut grass.

In the present invention, the configuration of the trimmer driving unit for driving the upper and lower trimmer blades 185 and 195 may be implemented using other configurations known in the technical field.

Referring to FIGS. 3 and 4, the second drive shaft 120 is inserted into and supported by a rectangular gear housing 101 having an internal accommodating space. The driven shaft 130 extends through a side surface of the gear housing 101 and is rotatably supported by the gear housing 101 via a bearing. A trimmer housing 107 is also coupled to and supported by the gear housing 101.

In a state in which the driving unit 110 is connected to the second drive shaft 120, driving-unit housings 104 and 105 rotatably support the driving unit 110. The driving-unit housings 104 and 105 include a first driving-unit housing 104 and a second driving-unit housing 105 that are coupled to each other from opposite sides so as to surround the driving unit 110. The driving-unit housings 104 and 105 are coupled to the gear housing 101.

A step member 102 that elastically returns by a spring 103 is coupled to the gear housing 101, and a second step portion 104a configured to be engaged with a step portion of the step member 102 is formed in the first driving-unit housing 104. A second step portion 105a configured to be engaged with the step portion of the step member 102 is also formed in the second driving-unit housing 105.

In a state in which the driving-unit housings 104 and 105 surround and are coupled to the driving unit 110, the adapter 115 is fastened to the driving unit 110. In this state, while the adapter driving portion 115a is connected to the female gear 120a of the second drive shaft 120, the driving-unit housings 104 and 105 are pressed toward the gear housing 101, such that the second step portions 104a and 105a are engaged with the step portion of the step member 102, whereby the driving-unit housings 104 and 105 are coupled to the gear housing 101 in a one-touch manner, and an additional fastening member may be fastened. With this configuration, power transmission components connected through the drive shaft can be stably supported and rotated with the gear housing 101 as a center.

Referring to FIGS. 7 and 8, the driven shaft 130 and the driven shaft gear 132 according to an embodiment of the present invention are illustrated.

Openings for inserting pins 133 are formed at both end portions of the driven shaft 130. Each pin 133 is inserted into the opening of the driven shaft 130 and protrudes upwardly and downwardly from the opening by a predetermined length. The protruding portion of the pin 133 includes a vertical portion 133a extending vertically, and an inclined portion 133b connected to the vertical portion 133a and extending obliquely downwardly. Reference numeral 134 denotes a bearing.

The driven shaft gear 132 includes driven-shaft gear teeth 132a that are operatively connected to the gear teeth 141 of the wheel 140. An opening into which the end portion of the driven shaft 130 is inserted is formed on an opposite side of the driven-shaft gear teeth 132a. Inside the opening, a step portion 132b configured to contact the vertical portion 133a to transmit power, and a rounded portion 132c connected to the step portion 132b and formed as a rounded inclined surface, are provided. The step portions 132b and the rounded portions 132c may be formed on an inner wall of the opening of the driven shaft gear 132 at intervals of 120 degrees, for example, in three positions.

With the pin 133 inserted into the end portion of the driven shaft 130, the driven shaft 130 is inserted into the opening of the driven shaft gear 132. When the driven shaft 130 rotates in a forward direction corresponding to a forward movement of the wheel 140, the vertical portion 133a of the pin 133 contacts the step portion 132b, such that the driven-shaft gear teeth 132a rotate and power is transmitted to the wheel 140.

When the wheel 140 rotates in a reverse direction, even though the driven-shaft gear teeth 132a operatively connected to the wheel 140 rotate, the rounded portion 132c and the inclined portion 133b come into contact with each other, such that power is not transmitted between the driven shaft gear 132 and the driven shaft 130. Accordingly, power is transmitted only during forward movement and is blocked during reverse movement of the reel-type rotary mower.

This configuration corresponds to what is commonly known as a one-way clutch. When the mower body is pulled backward for a change of direction or reworking while the driving force of the mower is continuously connected, power transmission is temporarily blocked, and when the handle is pushed forward after achieving the intended purpose, power transmission is resumed, allowing the mower to advance and perform cutting operations.

When operating the reel-type rotary mower according to the present invention, with the drive shaft operatively connected to the motor, an operator grips a handle and controls the reel-type rotary mower to cut grass.

When the motor rotates, rotational power of the motor is transmitted through the worm gear 121, the worm wheel gear 131, and the driven shaft gear 132, such that the wheels 140 are automatically rotated without requiring the operator to manually push the wheels 140. As the wheels 140 rotate, the blade shaft 150 operatively connected thereto rotates, and the blades 153 rotate according to rotation of the blade shaft 150 to cut grass. At the same time, the upper and lower trimmer blades 185 and 195 disposed at the front are driven to cut relatively large grass.

In the present invention, the side covers 170 serve to support the wheels 140, the driven shaft 130, and the blade shaft 150, and are connected to the weight 160 to allow the driven shaft 130, the wheels 140, the blades 153, and the trimmer blades 185 and 195 to operate smoothly, while absorbing vibrations generated during rotation.

According to the reel-type rotary mower of the present invention, since power for rotating the wheels 140 is supplied, a cutting width of the blades 153 can be increased, thereby providing an advantage of cutting a wide area of grass with a single operation.

In addition, compared to conventional mowers using rotating metal blades or nylon lines, scattering of cut materials is minimized, thereby enabling safe operation. Further, since grass and relatively large weeds are cut in a scissor-like manner by the blades 153 and the upper and lower trimmer blades 185 and 195, noise generation is reduced.

The present invention is not limited to the embodiments described above, and it will be apparent to those skilled in the art that various modifications and variations may be made without departing from the spirit and scope of the present invention.

### DESCRIPTIONS OF REFERENCE NUMERALS

101: Gear housing
102: Step member
103: Spring
104, 105: Driving-unit housings
107: Trimmer housing
108: Front cover
109: Second front cover
110: Driving unit
111: Driving rotary portion
120: Second drive shaft
120a: Female gear
121: Worm gear
122: Spur gear
123: Reduction gear
124: Trimmer driving gear
130: Driven shaft
131: Worm wheel gear
132: Driven shaft gear
132a: Driven-shaft gear teeth
132b: Step portion
132c: Rounded portion
133: Pin
133a: Vertical portion
133b: Inclined portion
140: Wheel
141: Gear teeth
145: Wheel connecting shaft
150: Blade shaft
151: Blade gear
152: Blade plate
153: Blade
160: Weight
161: Groove-forming portion
161a: Connecting groove
170: Side cover
171: Driven-shaft opening
172: Wheel-connecting-shaft opening
173: Blade-shaft opening
181: First eccentric rotary portion
182: First crank bar
182a: First crank opening
183: Upper connection plate
185: Upper trimmer blade
191: Insertion rotary portion
192: Second crank bar
192a: Second crank opening
193: Second eccentric rotary portion
194: Lower connection plate
195: Lower trimmer blade

1. A reel-type rotary mower, comprising:
a driving unit connected to a drive shaft configured to receive power from a motor;
a driven shaft disposed to intersect the driving unit and extending in a transverse direction, the driven shaft being operatively connected to the driving unit and configured to rotate by rotation of the drive shaft;
side covers inserted into the driven shaft and spaced apart from each other, the side covers being disposed respectively on opposite sides of the driven shaft;
wheels coupled to the side covers, each wheel having gear teeth formed along an inner circumferential surface thereof and being gear-engaged with an end portion of the driven shaft so as to rotate in response to rotation of the driven shaft;
a blade shaft gear-engaged with the gear teeth and configured to rotate together with rotation of the gear teeth;
a plurality of blades connected to the blade shaft and extending in the transverse direction; and
a weight rotatably connected between the side covers and configured to support a load,
wherein rotational power of the motor is sequentially transmitted to the drive shaft, the driven shaft, and the wheels, such that the blades rotate to cut grass.

2. The reel-type rotary mower according to claim 1,
wherein each of the side covers includes:
a driven-shaft opening into which an end portion of the driven shaft is inserted and rotatably supported; and
a blade-shaft opening into which an end portion of the blade shaft is inserted and rotatably supported.

3. The reel-type rotary mower according to claim 1, further comprising:
a second drive shaft operatively connected to the drive shaft and extending in a longitudinal direction;
an upper trimmer blade and a lower trimmer blade disposed in front of the wheels in the transverse direction; and
a trimmer driving unit operatively connected to the second drive shaft and coupled to the upper trimmer blade and the lower trimmer blade, the trimmer driving unit being configured such that rotation of the second drive shaft causes the upper trimmer blade and the lower trimmer blade to repeatedly move toward and away from each other to cut relatively large grass,
wherein rotation of the second drive shaft causes the driven shaft, the upper trimmer blade, and the lower trimmer blade to be driven together.

4. The reel-type rotary mower according to claim 3, wherein:
the driving unit includes a driving rotary portion configured to rotate together with rotation of the drive shaft;
an adapter includes an adapter driving portion coupled to the driving unit and gear-engaged with the driving rotary portion so as to rotate; and
the second drive shaft is gear-engaged with the adapter driving portion so as to rotate.
